(19) United States
(12) Patent Application Publication
(10) Pub. No.: US 2023/0078352 A1
(43) Pub. Date: Mar. 16, 2023

(54) METHOD AND SYSTEM FOR IDENTIFYING A PACKAGING MATERIAL FOR RECYCLING

(71) Applicant: PACCOR Packaging GmbH, Dosseldorf (DE)

(72) Inventors: Helmut Ruland, Elsdorf (DE); Andreas Schütte, Meerbusch (DE)

(21) Appl. No.: 17/903,983

(22) Filed: Sep. 6, 2022

(30) Foreign Application Priority Data
Sep. 14, 2021 (DE) 10 2021 123 789.0
Dec. 14, 2021 (DE) 10 2021 133 107.2

(51) Int. Cl. G06Q 10/00; G06K 7/14

(52) U.S. Cl. CPC G06Q 10/30; G06K 7/1417

(57) ABSTRACT

Method of identifying a packaging material for recycling comprising the steps of:

a. Providing a container for packaging a product with a container inherent code;

b. Creating an entry in a database associated with the container inherent code, the entry containing at least data on packaging materials used in the production of the container;

c. Providing at least one read-out device for reading out the container-inherent code;

d. Reading out the container inherent code;

e. Retrieving the data of the entry from the database for recycling the container.

### PRIORITY CLAIM

This application claims priority from Germany Patent Application No. 10 2021 123 789.0 filed Sep. 14, 2021 and Germany Patent Application No. 10 2021 133 107.2 filed Dec. 14, 2021, the contents of which are incorporated herein by reference in their entirety.

### FIELD OF THE INVENTION

The invention relates to a method for identifying a packaging material for recycling and a system for tracking a container during a life cycle of the container.

### BACKGROUND OF THE INVENTION

Various different packaging solutions are known from the prior art. Packaging for foodstuffs is of particular importance, as special requirements are placed on the packaging materials used for this purpose. In order to meet the requirements with regard to hygiene, printability and barrier properties for contamination, foodstuffs are predominantly packed in packaging made of plastics.

In view of the problems associated with the use of plastics for packaging, such as insufficient recyclability, pollution during thermal recycling and poor degradability, efforts are being made to replace plastics with alternative materials. This endeavour has been further increased in particular by the current discussion of plastic residues in the world's oceans and microplastics in the environment.

In order to increase the proportion of recyclable plastics and, in particular, to increase the reusability of the plastics obtained during recycling, it is necessary to separate plastics by type. This is not only advantageous in terms of reducing the proportion of waste that has to be disposed of thermally, but also makes economic sense, since single-variety plastics represent a valuable raw material.

Already today, packaging made of plastic often has a print or embossing that gives an indication of the packaging material. Similarly, there have been efforts for some time to make packaging from only one material, if possible, so that the entire packaging can be disposed of together. The formation of packaging from only one material reduces the likelihood that several different materials of a single packaging will remain inseparable during recycling and will be reprocessed together. Reprocessing packaging made of multiple plastics together would result in one of the plastics being present in the recyclate as an impurity of the other plastic.

For example, a method for coding different packages is known from patent applications US 2019/ 0 306 385 A1 and DE 10 2020 125 214 A1. In this process, a code is applied in a highly repetitive manner to surfaces of the packaging or is introduced into the packaging in the vicinity of the surface. Due to the high redundancy of this code and its arrangement on a multitude of surface sections, which may be oriented differently, the reading of this code is possible regardless of the orientation of the packaging.

Due to the large number of plastics used for packaging, it is not possible, or at least not intended, to separate the plastics by type, especially in the private sector. So even if the plastic contained in a plastic packaging is indicated on the packaging, it is still disposed of together with other plastic packaging that may contain other plastics. In Germany, for example, plastic packaging is often marked with the so-called “green dot” and is disposed of in the private sector in the so-called “yellow bag” or the “yellow bin” regardless of the plastic it contains.

For recycling purposes, some of the plastics contained in such a mixture of different plastics can be identified and subsequently separated. The procedures required for this use, for example, spectroscopic methods to identify certain plastics in packaging. However, these methods are very complex, slow, require expensive equipment and are often not able to separate multi-component packaging by type.

### SUMMARY OF THE INVENTION

Accordingly, the invention is based on the object of providing a method for identifying a packaging material for recycling as well as a system with which the materials of a packaging supplied for recycling can be easily identified.

This task is solved by a method with the features of claim 1, as well as by a system according to claim 8. Advantageous embodiments of the invention can be found in the dependent patent claims.

### BRIEF DESCRIPTION OF THE DRAWINGS

Preferred and alternative examples of the present invention are described in detail below with reference to the following drawings. Moreover, further aims, advantages and usefulness of the present invention are explained with reference to the accompanying drawings and the following description. Hereby shown is:

FIG. 1 schematically illustrates a system for identifying a packaging material for recycling according to a preferred embodiment.

### DETAILED DESCRIPTION OF THE PREFERRED EMBODIMENT

The main idea of the invention is a method for identifying a packaging material for recycling, comprising the steps:
a. Providing a container for packaging a product with a container inherent code;
b. Creating an entry in a database associated with the container inherent code, the entry containing at least data on packaging materials used in the production of the container;
c. Providing at least one read-out device for reading out the container inherent code;
d. Reading the container inherent code;
e. Retrieving the data of the entry from the database for recycling the container.

In the context of the present invention, the terms “packaging” and “container” are used interchangeably.

The step of providing the container with the container inherent code is preferably performed in such a way that the container is provided and this container is provided with a code already. Preferably, the code is non-detachably attached to the container. For example, the code may have been bonded to the container by a surface treatment of the container. Such a surface treatment could be, for example, printing, engraving or, in the case of at least some plastics, also conceivable and, in some embodiments, preferably a local modification of the material and/or surface property, for example, by thermal treatment and/or laser impact. One advantage of the indissoluble connection of code and container is that once an assignment has been made between a code and a container, it remains permanently in place. When the container is manufactured, the manufacturer of the container is aware of the materials used for this purpose. If the code establishes a link between this container and the materials used to manufacture it, this can be tracked over the entire life cycle of the container and recycling can be selected and carried out accordingly. An erroneous re-linking between a code and a container, such as might occur when a label containing the code is stuck on or a band containing the code is put over, can thus be effectively avoided.

According to a preferred embodiment, a plurality of containers is provided.

Preferably, the container inherent code is only associated with a particular container, batch of containers or type of containers. In particular, it is preferred that the container inherent code is assigned separately for each individual container and is preferably unique. This makes it possible to identify each individual container precisely.

Preferably, the manufacturer of the container not only permanently attaches the code to the container during production, but also creates an entry in a database. This entry also contains at least data on the materials used in the production of the container.

According to a preferred embodiment, a container inherent code is unique during a life cycle of the container. Preferably, at the end of the life cycle, the unique code is assignable to a further container at the beginning of a life cycle of the further container.

Preferably, each code is a one-time code. Alternatively or additionally, however, it is also conceivable that a code is reassigned after the container assigned to it has been recycled. In this case, such a one-time code exists only once during the product cycle of a package, but can be reassigned after the container assigned to this code has been destroyed.

According to a preferred embodiment, the entry in the database for the coded container is retrievable at any location and by any person or device handling the container during the life cycle of the container.

The step of providing a read-out device for reading out the container inherent code is preferably not performed exclusively for recycling, but may be provided at any location and by anyone handling the container, as described above. In particular, however, it is preferred that the container inherent code is read out at the end of the product cycle by means of a read-out device.

According to a preferred embodiment, the entry contains further data, the further data being selected from a group consisting of a volume of the container, a shape of the container, a compatibility of the container with a container closure, a compatibility with excipients, a suitability of the container for packaging certain goods, a suitability of the container under certain environmental conditions, a time interval within which the container can be used for packaging a product, a time interval over which the sterility of the container can be ensured.

In this way, it is possible that safe handling can also be ensured when this packaging is used later, for example for packaging goods. For example, a service provider who packages a product could read the code by means of a suitable reader and obtain the information associated with this code.

According to a preferred embodiment, the method comprises the step of supplementing and/or modifying the entry in the database at each handling step of the container by at least one further piece of information, said information being selected from a group comprising a product contained in the container, a production date of the product, a production date of the container, a packaging date, an expiry date of the product, a reference to a responsible employee, a reference to a product manufacturer, a reference to a product manufacturer, a reference to a product manufacturer, a reference to a product manufacturer, a reference to a product manufacturer, a reference to a product manufacturer, a reference to a product manufacturer, a reference to a responsible employee, a place of production of the container and/or the product, a place of packaging, a time of production, a time of packaging, a distribution channel, a part of a distribution channel, a transporter, an intermediary, a wholesaler, a retailer, a sale to an end user, a hazard statement, a safety instruction, a storage instruction, a storage temperature.

Preferably, it is also possible for companies and/or private individuals to add to and/or change the entry in the database associated with a code.

Preferably, an additional entry is generated in the database at each treatment step of the container. This would make it possible to trace the entire life cycle of the product packaged in the container. This would allow the customer to be protected against product counterfeiting, for example, or to track overstocking or to track improper storage (for example, the interruption of the cold chain).

Preferably, the record also includes information about the sale to an end customer. This information can be important for recycling as it indicates that the product has been used, for example consumed by the end customer, and it can be assumed that the packaging has been emptied. If packaging is detected during recycling that has never been sold to an end customer, it can be assumed that the product has been destroyed, for example due to over-storage or improper storage, whereby the container has usually not been emptied and therefore cannot be recycled in a single type without appropriate pre-treatment.

If, for example, in the above-mentioned step the code of the container is also linked, for example by the manufacturer, to a product contained in the container, the product contained in the container can also be uniquely identified. This makes it possible, for example, to trace the authenticity of the product contained and/or its packaging date (and any resulting best-before date).

According to a preferred embodiment, the method comprises the further step of determining a suitable recycling process for the container based on the entry stored in the database.

According to the invention, after reading the container inherent code, the data associated with this container is retrieved from the database. Since this database not only contains the materials used for its manufacture, but preferably also information on individual stations and treatments of the container, a corresponding recycling process can be carried out. This makes it possible to obtain homogeneous recyclates.

An embodiment in which each container contains multiple copies of the code assigned to this container has proven to be particularly advantageous. This means that it is not necessary to have the entire container in order to select a suitable recycling for this part of the container. If, for example, the container is cut, torn or otherwise divided into several parts when the packaging is opened, the appropriate recycling for each part containing the code is still possible. This is also advantageous if, during waste disposal, for example pressing and/or shredding, the waste and thus also a container provided with a code is divided into parts. In this case, too, the appropriate recycling can still be selected for each part containing the code.

The object is further solved by a system according to claim 8. The system may be provided with all the features already described above in the context of the method, individually or in combination with each other, and vice versa.

According to the invention, the system for identifying a packaging material for recycling comprises connecting means for connecting a container for packaging a product with a container inherent code, a database for storing an entry associated with the container inherent code, the entry containing at least data on packaging materials used in the production of the container, the database being connected to at least one receiving means for receiving data of the entry and requests of the data of the entry, and to at least one transmitting means for responding to the request, and a reading means provided and adapted to read the container inherent code and to retrieve the data of the entry associated with the container inherent code.

In particular, it is a system for tracking a packaging from its production to its disposal. Such a system comprises a device for connecting a code to a container. This connection device is preferably already provided on the production side, so that a code is already assigned to the respective container during its production. This code is preferably not (non-destructively) detachably connected to the container.

The connecting device preferably comprises a printing device, a forming device and/or a laser device. As described above in terms of the process, the code can be applied to the container or introduced into the container by means of a pressure or a laser impact. It would also be conceivable for the container to be formed, at least in sections, around an element containing the code. This is particularly conceivable for transparent materials.

The system further comprises a storage device for a database. This storage device is preferably connected to at least one transmitting device and at least one receiving device. The receiving device can receive data associated with a specific code. Likewise, the receiving device enables the acceptance of requests for a code. Such a request can be answered by a transmitting device.

Preferably, an entry characteristic of a particular container and/or code is already stored in this database by the manufacturer of the container.

Furthermore, the system comprises at least one read-out device for reading out the container inherent code. Such a read-out device is provided to select the recycling process suitable for this container.

According to a preferred embodiment, the read-out device can be integrated in a mobile phone, whereby the readout device can be called up in the form of an app of the mobile phone.

A further read-out device can preferably be arranged at an end user, for example in the form of an app, preferably on a mobile phone. This enables the end user to retrieve information stored in the database about the product contained in a particular container.

A further read-out device can preferably be provided at a logistics service provider, such as a transport company or a warehouse, a wholesaler and/or a retailer. This also enables them to scan the code of the packaging and to add to the entry associated with this code in the database additional information characteristic of the product contained in the container and/or the packaging during the period of stay with this company.

According to a preferred embodiment, the database is connected to the internet. Preferably, the database is accessible via the Internet, at least for consultation, in order to enable both companies that use a container provided with a code as described above for packaging products or that further handle (for example, transport, store or sell) a product packaged in such a container, and private individuals and/or end consumers to access this database. This makes it possible for this group of persons to identify a packaging and thus also to query the information stored in this database about the product contained therein.

In particular, it is preferred that the database is a cloud-based database.

Preferably, the step of manufacturing the container comprises a thermoforming operation.

Preferably, the container comprises a material selected from a group comprising PP, PE PUR, PS, PU, HDPE, PA, paper, cardboard and others. In particular, it is preferred that the container comprises a single material of this group. If it is intended that the container comprises several materials of this group, it is preferred that each container section consisting of a different material is given its own code which is different from the code of another section. This latter possibility allows, after the container has been crushed and divided into fragments, the materials of the individual fragments to be identified by means of the code and to be recycled according to the material they contain.

In particular, it is preferred that the code is assigned to the container by ablating, or melting or engraving minute code patterns into the surface of the inner surfaces of a tool mould for manufacturing the container.

Preferably, the code assigned to this container is applied in identical form multiple times to wall and bottom surfaces of the container or an associated component.

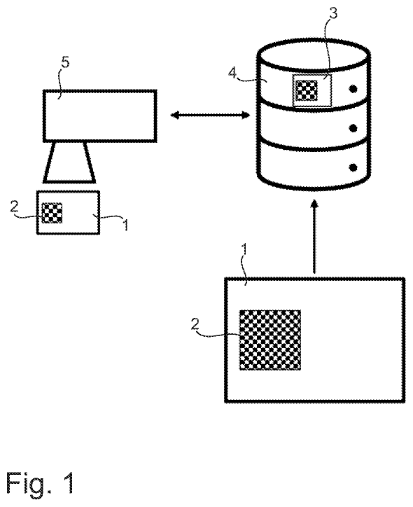

For the method, which can be executed by a system schematically shown in FIG. 1, a container 1 for packaging a product is first provided with a container inherent code 2. The pattern of the code 2 is shown only schematically. In a next step, an entry 3 associated with the container inherent code 2 is created in a database 4, the entry 3 containing at least data on packaging materials used in the production of the container. Furthermore, a read-out device 5 is provided for reading out the container inherent code 2 located on the container. By means of the read-out device 5, the container inherent code 2 is read out in a next step. Using the read-out code 2, data of the entry 3 is retrieved from the database 4 for the recycling of the container 1.

Features disclosed in the application documents may be claimed as essential to the invention, provided they are individually or in combination new compared to the prior art.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method of identifying a packaging material for recycling, comprising the steps of:
a. providing a container for packaging a product with a container inherent code;
b. creating an entry in a database associated with the container inherent code, wherein the entry contains at least data on packaging materials used in the production of the container;
c. providing at least one read-out device for reading out the container-inherent code;
d. reading out the container inherent code; and
e. retrieving the data of the entry from the database for recycling the container.

2. The method of claim 1, further comprising a plurality of containers, wherein the plurality of containers includes at least one of (a) a single container provided with a unique container inherent code, (b) a group of containers of a specific type with a unique container inherent code, or (c) a group of container of a specific batch with a unique container inherent code.

3. The method of claim 2, wherein
a container inherent code is unique during a life cycle of the container, and
after the end of the life cycle the unique code is assignable to a further container at the beginning of a life cycle of the further container.

4. The method of claim 3, wherein the entry in the database for the container provided with the code can be retrieved during the life cycle of the container at any location via the read-out device.

5. The method of claim 1, wherein the entry in the database for the container provided with the code contains further data selected from a group comprising: a volume of the container, a shape of the container, a compatibility of the container with a container closure, a compatibility with auxiliary substances, a suitability of the container for packaging certain goods, a suitability of the container in certain environmental conditions, a time interval within which the container can be used for packaging a product, a time interval over which the sterility of the container can be ensured.

6. The method of claim 1, wherein the container is subject to a plurality of recycling treatment stages, and further comprising the step of modifying the entry in the database at each treatment stage of the container to include further data selected from a group comprising: a product contained in the container, a production date of the product, a production date of the container, a packaging date, an expiry date of the product, an indication of a responsible employee, a place of production of the container and/or the product, a packaging location, a production time, a packaging time, a distribution channel, a section of a distribution channel, a transporter, an intermediary, a wholesaler, a retailer, a sale to an end user, a hazard warning, a safety instruction, a storage instruction, a storage temperature.

7. The method of claim 1, further comprising the step of determining a suitable recycling method for the container based on the entry stored in the database.

8. A system for identifying a packaging material for recycling, comprising
a connecting device for connecting a container for packaging a product with a container inherent code;
a database for storing an entry associated with the container inherent code, the entry containing at least data on packaging materials used in the production of the container;
at least one receiving device connected to the database and configured to receive data of the entry and requests of the data of the entry;
at least one transmitting device for answering a request for the data of the entry; and
a read-out device configured to read the container inherent code and to retrieve the data of the entry associated with the container inherent code.

9. The system of claim 8, wherein
the read-out device is configured to integrate in a mobile telephone, and
the read-out device can be called up in the form of an app of the mobile telephone.

10. The system according to claim 8, wherein the database is a cloud-based database connected to the Internet.

11. The system according to claim 9, wherein the database is a cloud-based database connected to the Internet.
